(19) United States
(12) Patent Application Publication
(10) Pub. No.: US 2013/0144721 A1
(43) Pub. Date: Jun. 6, 2013

(54) INDIVIDUALIZATION SERVICE PROVIDING SYSTEM, SERVER, TERMINAL USING USER'S FEED BACK AND PRIVACY BASED ON USER AND METHOD THEREOF

(71) Applicant: Electronics and Telecommunications Research In, Daejeon (KR)

(72) Inventors: Jong-Hyouk NOH, Daejeon (KR); Seok Hyun KIM, Daejeon (KR); Young Seob CHO, Daejeon (KR); Sangrae CHO, Daejeon (KR); Soo Hyung KIM, Daejeon (KR); Seung-Hyun KIM, Daejeon (KR); Jin-Man CHO, Daejeon (KR); Dae Seon CHOI, Daejeon (KR); Seung Hun JIN, Daejeon (KR)

(73) Assignee: Electronics and Telecommunications Research Institute, Daejeon (KR)

(21) Appl. No.: 13/679,736

(22) Filed: Nov. 16, 2012

(30) Foreign Application Priority Data
Dec. 5, 2011 (KR) 10-2011-0128761

(51) Int. Cl. G06Q 30/02

(52) U.S. Cl. CPC G06Q 30/0269
USPC 705/14.55; 705/14.66

(57) ABSTRACT

An individualization service providing system based on a user includes an individualization service client configured to be mounted in a user terminal to collect user's individualization information, generate a user profile by anonymizing the individual information according to a privacy policy, and transmit the generated user profile through a communication network, along with an individualization service request message. Further, the individualization service providing system includes an individualization service server configured to recommend individualization services corresponding to the user profile and provide the recommended individualization services to the individualization service client, at the time of receiving the individualization service request services.

### CROSS-REFERENCE TO RELATED APPLICATIONS

The present invention claims priority of Korean Patent Application No. 10-2011-0128761, filed on Dec. 05, 2011 which is incorporated herein by reference.

### FIELD OF THE INVENTION

The present invention relates to an individualization service providing system based on a user; and more particularly, to an individualization service providing server, a system, and a terminal used on a user, and a method thereof, which are capable of solving a privacy problem by collecting and storing user's individual information in an individualization service client installed in a mobile terminal, anonymizing the collected user's individual information, and configuring a user profile and transmitting the configured user profile to the server and providing more accurate individualization services by feed backing and providing information selected by the user to the individualization service information based on user profile information provided from the server, in providing the individualization service based on a user under mobile environment.

### BACKGROUND OF THE INVENTION

An individualization service means providing services suitable for individuals at the time of providing services. With the development of Internet environment, web site individualization becomes one of the important factors of success in an Internet business market.

Major sites such as Amazon, auction, Google, and the like, have provided individualization services for a long time. A method for allowing the sites to provide the individualization services analyzes purchase patterns of users from a database in which records purchased by users are stored for many years to provide recommendation services. In this case, as technologies that have been mainly used until now, correlation analysis, collaborative filtering, and the like, has been used.

Recently, an accident that individualization information is leaked in large quantities in portal sites, and the like, due to hacking has occurred. In order to prevent the leakage accident, various security technologies have been suggested. However, one of the most effective methods is a method that does not store user's information in the server.

As described above, the individualization service based on a user is suitable for, in particular, mobile environment. The reason is that various types of user's information are stored in mobile terminals such as a smart phone. The user's information corresponds to a telephone, a telephone directory, an address book, e-mail, an individual schedule, positional information, and the like. The information well represents a user's taste and condition and therefore, can be configured as individualization services different from server centered individualization services.

However, when the user's information of a terminal is provided to the server providing the individualization services as they are, the privacy problem of the user information may occur, similarly to a server based method.

### SUMMARY OF THE INVENTION

In view of the above, the present invention provides an individualization service providing server, a system, and a terminal used on a user, and a method thereof, which are capable of solving a privacy problem by collecting and storing user's individual information in an individualization service client installed in a mobile terminal, anonymizing the collected user's individual information, and configuring a user profile and transmitting the configured user profile to the server and providing more accurate individualization services by feedbacking and providing select information by the user regarding the individualization service information based on user profile information provided from the server, in providing the individualization services based on a user under mobile environment.

### BRIEF DESCRIPTION OF THE DRAWINGS

The objects and features of the present invention will become apparent from the following description of embodiments given in conjunction with the accompanying drawings, in which:

FIG. 1 is a configuration diagram of an individualization service system based on a user in accordance with an embodiment of the present invention;

FIG. 2 is a detailed block diagram of an individualization service client and a server in accordance with an embodiment of the present invention; and

FIG. 3 is a flow chart illustrating control processes of individualization service in accordance with an embodiment of the present invention.

### DETAILED DESCRIPTION OF THE EMBODIMENTS

Advantages and features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this disclosure will be thorough and complete and will fully convey the concept of the invention to those skilled in the art, and the invention will only be defined by the appended claims.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, embodiments of the present invention will be described in detail with reference to the accompanying drawings.

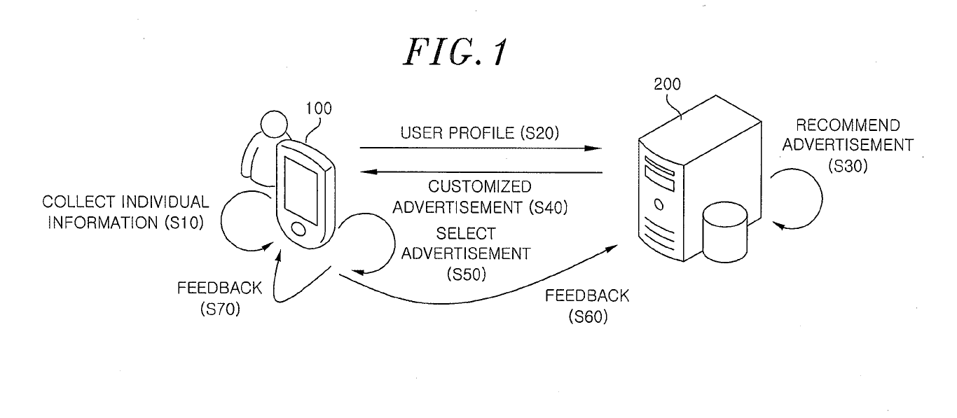

FIG. 1 illustrates a configuration of an individualization service system based on a user, which is capable of securing privacy in accordance with an embodiment of the present invention. The system of the present invention will be described with reference to an individual customized advertising service.

Referring to FIG. 1, a mobile terminal is provided with an individualization service client 100 capable of collecting individual information to collect user's individual information.

The individualization service client 100 of the mobile terminal collects the user's individual information (S10). The collected user's individual information may include individual information including an address, an occupation, age, and the like, positional information, purchase information, and the like. The user's individual information is directly input by a user or is collected using a collection function of the client 100.

The collected user's individual information is subjected to an anonymization process and then, is configured of a user profile, which is in turn transmitted to an individualization service server 200 (S20). Hereinafter, an example in which the individualization service server 200 is an advertising server will be described. That is, the advertising server 200 uses the received user profile to select advertisement to be recommended to a user (S30). The selected advertisement is transmitted to the individualization service client 100 of the mobile terminal (S40). The individualization service client 100 of the mobile terminal shows the received customized advertisement to the user.

When the user selects advertisement (S50), i.e., feedback information is transmitted to the advertising server 200 (S60) to improve an advertising recommendation function of the advertising server 200. The individualization service client 100 also uses the feedback information (S70) to improve the user's profile configuration.

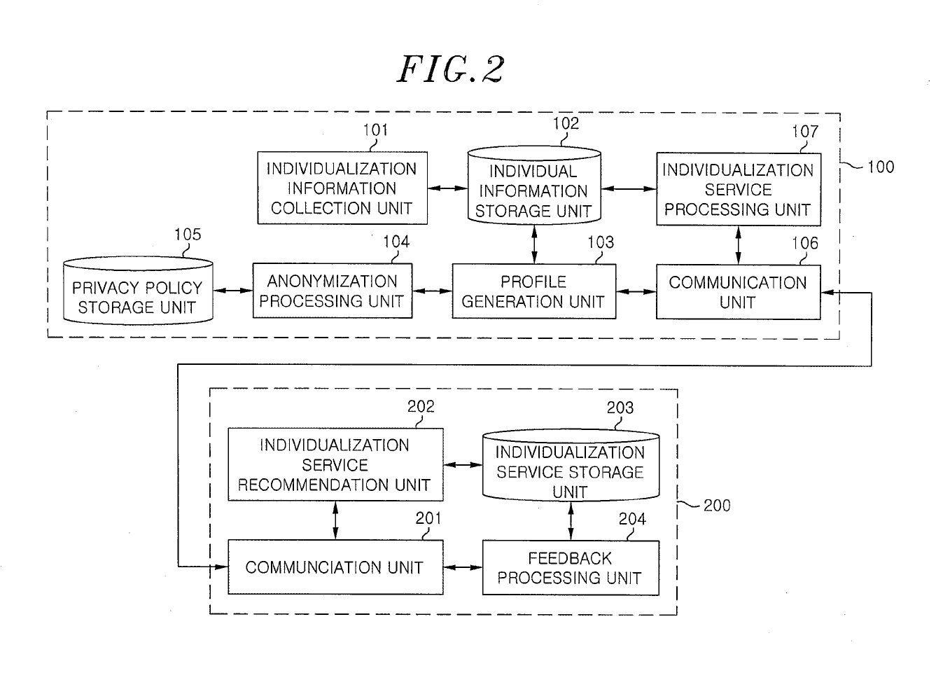

FIG. 2 illustrates a detailed block diagram of the individualization service client 100 and the individualization service server 200.

Referring to FIG. 2, the individualization service client 100 is provided with a mobile terminal. An individual information collection unit 101 of the individualization service client 100 collects the user's individual information. The user's individual information is directly input by a user or is collected by a separate information collection function. An example of the collected individual information may include individual information including an address, an occupation, age, and the like, positional information, purchase information, preference information, and the like, of the user. The user's individual information collected by the individual information collection unit 101 is stored in an individual information storage unit 102.

The individualization service client 100 needs to transmit the user profile to the individualization service server 200 to receive the individualization services. A profile generation unit 103 accesses the individual information storage unit 102 to obtain data suitable for the individualization services to be used and then transmit the obtained data to an anonymization processing unit 104. The anonymization processing unit 104 accesses a privacy policy storage unit 105 to bring the privacy policy and then, anonymizes the individual information data transmitted from the profile generation unit 103.

In this case, the anonymization process includes two controls. One of the two is a profile term control determining whether items are included in a profile. The other is a term range control that determines a range of data among the terms included in the profile. The term range control defines, e.g., whether or not to minutely represent a user's address till Dong or broadly represent a user's address till City. As another example, the term range control defines whether or not to minutely represent an occupation till a programmer and broadly represent an occupation till IT industry employees.

The profile generation unit 103 receives the anonymized data from the anonymization processing unit 104 and then, configures the profile, which is in turn transmitted to a communication unit 106. The communication unit 106 transmits an individualization service request message including the user profile to the individualization service server 200.

The communication unit 201 of the individualization service server 200 receives the individualization service request service from the individualization service client 100. The communication unit 201 analyzes the request message to transmit the user profile included in the message to an individualization service recommendation unit 202. The individualization service recommendation unit 202 obtains the individualization services suitable for the user profile to the individualization service storage unit 203. The recommendation type uses the user profile information and context information of the individualization service storage unit 203.

The context information means the users' information that prefers the individualization services. For example, the individualization service called washing machine advertisement corresponds to information preferred by a woman and computer component advertisement corresponds to information preferred by a university student, IT industry employees, and thirties. The context information is input when the individualization service is registered in the individualization service server 200.

The recommended individualization services are transmitted to the communication unit 201 and the communication unit 201 transmits the individualization services to the communication unit 106 of the individualization service client 100.

The communication unit 106 of the individualization service client 100 that receives the individualization services transmits the individualization services to the individualization service processing unit 107 that processes the individualization services. For example, when the individualization service is advertisement, the individualization service processing unit 107 appropriately shows the advertisement using a graphic user interface (GUI). The individualization service processing unit 107 may be present at the outside of the individualization service client 100 according to the individualization services.

When a user selects the individualization services provided by the individualization service processing unit 107, the selected information (feedback information) is transmitted to the individualization service server 200 and the individualization service client 100 also processes the selected information. The use of the feedback information is to increase the individualization service recommendation accuracy.

When the individualization services are recommended by the individualization service server 200, the services suitable for the user profile are selected but services satisfying only a part of the profile are selected together. The reason is that it is not determined that the individualization profile transmitted by the individualization service client 100 does accurately reflect the user. When the individualization service client 100 collects individual information, the individualization service client 100 can collect inaccurate information and the user cannot correctly record his/her own taste. In addition, even though the user accurately records his/her own taste, it is difficult for a specific occupational cluster and specific ages to have the same taste.

Further, it may not be secured that the context information regarding the individualization services stored in the individualization service server 200 is correctly input. For example, it is determined that goods called ‘A’ attract forties attention, but which the goods may attract twenties attention.

As described above, the client's individual information and the server's context information may be inaccurate. In order to improve the above problem, the embodiment of the present invention uses the feedback information selected by the user to update the client's individual information and the context information of the individualization service server 200. The feedback information includes the service information selected by the user and the user profile information.

When the communication unit 201 of the individualization service server 200 receives the feedback information, the communication unit 201 hands over the received feedback information to the feedback processing unit 204. The feedback processing unit 204 extracts the user profile included in the feedback information. The extracted information is separately stored in the individualization service storage unit 203. When the user profile information is collected to some extent, the most common data are searched and then, added to the stored context information. For example, when the information that goods expected to be preferred by forties attract twenties and thirties attention is accumulated, the most related ages are added to the context information. That is, both of the initial storage value and the feedback information is stored in the context information. Hereinafter, when a large amount of feedback information is accumulated, it may be replaced with the feedback information, instead of the initial storage value.

When the individualization service processing unit 107 of the individualization service client 100 recognizes the feedback of the user, the context information of the service is stored in the storage unit 102. When the service context information is collected to some extent, common data are found to update the stored user's individual information. For example, the user's preference information is IT related goods, but when an item receiving user attention is clothes, a clothes item is included in the user preference information.

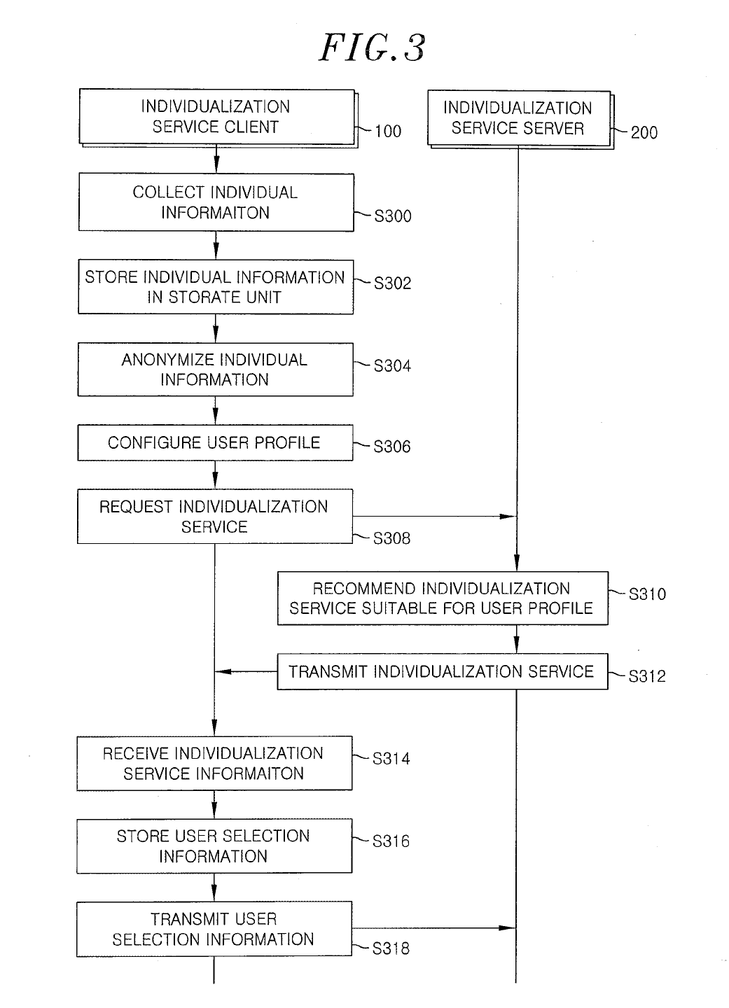

FIG. 3 illustrate a signal processing flow for providing the individualization service in the individualization service system based on a user capable of securing privacy in accordance with the embodiment of the present invention. Hereinafter, the embodiment of the present invention will be described in detail with reference to FIGS. 1, 2, and 3.

First, the individualization service client as illustrated in FIG. 2 capable of collecting the user's individual information to provide the individualization service to portable mobile communication terminals such as a mobile phone, and the like, may be installed.

The individualization service client 100 installed as described above collects the individualization information in step S300. In this case, the individual information is directly input by a user but, a method for collecting individual information uses a separate information collection function. An example of the collected individual information may include individual information including an address, an occupation, age, and the like, positional information, purchase information, preference information, and the like, of a user.

Then, the individualization service client 100 stores the collected individual information in the individual information storage unit 102 in step S302.

Up to the foregoing processes S302, the previous operation of the client 100 for receiving the individualization service is described. Hereinafter, the process of processing the individualization service will be described from step S304.

In this case, the individualization service client 100 needs to transmit the user profile to the individualization service server 200 to receive the individualization services.

Therefore, the individualization service client 100 anonymizes the individualization information stored in the individual information storage unit 102 in step S304.

That is, the individualization service client 100 brings the privacy policy from the privacy policy storage unit 105 and then, anonymizes the individual information data transmitted from the profile generation unit 103 through the anonymization processing unit 104.

In this case, the anonymization process includes two controls. One is a profile term control determining whether items are included in a profile. The other is a term range control that determines a range of data among the terms included in the profile. The term range control defines, for example, whether or not to minutely represent a user's address till Dong or broadly represent a user's address till City. As another example, the term range control defines whether or not to minutely represent an occupation till a programmer and broadly represent an occupation till IT industry employees.

Next, the individualization service client 100 configures the individual information data anonymized by the anonymization processing unit 104 as the user profile by the profile generation unit 103 in step 5306 and transmits the individualization service request message including the user profile to the individualization service server 200 through the communication unit 106 to request the individualization services in step S308.

Then, the individualization service server 200 receives the individualization service request message from the individualization service client 100 and analyzes the individualization service request message to recommend the individualization services meeting the user profile in step S310.

That is, the individualization service server 200 analyzes the individualization service request message to bring the individualization services suitable for the user profile from the individualization service storage unit 203.

In this case, the recommendation type uses the user profile information and context information of the individualization service storage unit 203.

The context information means the users' information that prefers the individualization services. For example, the individualization service called washing machine advertisement corresponds to information preferred by a woman and computer component advertisement corresponds to information preferred by a university student, IT industry employees, and thirties. The context information is input when the individualization service is registered in the individualization service server 200.

Next, the individualization service server 200 transmits the recommended individualization services to the individualization service client 100 through the communication unit 201 in step S312.

In this case, the individualization service client 100 may receive the individualization services recommended from the individualization service server 200 in step S314 and transmit the individualization services to the individualization service processing unit 107 to execute the individualization services through the individualization service processing unit 107. In this case, when the individualization service is advertisement, the individualization service processing unit 107 appropriately shows advertisement using a graphic user interface (GUI).

As described above, the user may select the specific individualization service among the individualization services provided by the individualization service processing unit 107 and when there is user selection, the individualization service client 100 stores user selection information in step S316 and transmits the user selection information to the individualization service server 200 in step S318.

As described above, the user selection information is transmitted to the individualization service server 200 and the individualization service client 100 also processes the user selection information. The use of the feedback information is to increase the individualization service recommendation accuracy.

In other words, when the individualization services are recommended by the individualization service server 200, the services suitable for the user profile are selected but services satisfying only a part of the profile are selected together. The reason is that it is not determined that the individualization profile transmitted by the individualization service client 100 does accurately reflect the user. When the individualization service client 100 collects individual information, the individualization service client 100 can collect inaccurate information and the user cannot correctly record his/her own taste. In addition, even though the user accurately records his/her own taste, it is difficult for a specific occupational cluster and specific ages to have the same taste.

Further, it may not be secured that the context information regarding the individualization services stored in the individualization service server 200 is correctly input. For example, it is determined that goods called ‘A’ attract forties attention, but which the goods may attract twenties attention.

As described above, the client's individual information and the server's context information may be inaccurate. In order to improve the above problem, the embodiment of the present invention uses the feedback information selected by the user to update the client's individual information and the context information of the individualization service server 200. The feedback information includes the service information selected by the user and the user profile information.

As described above, the embodiment of the present invention can solve the privacy problem by collecting and storing the user's individual information in the individualization service client installed in the mobile terminal, anonymize the collected user's individual information, and configure the user profile and transmit the configured user profile to the server and provide the more accurate individualization services by feedbacking and providing the select information by the user regarding the individualization service information based on the user profile information provided from the server, in providing the individualization services based on a user under the mobile environment.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An individualization service providing system based on a user, comprising:
an individualization service client configured to be mounted in a user terminal to collect user's individualization information, generate a user profile by anonymizing the individual information according to a privacy policy, and transmit the generated user profile through a communication network, along with an individualization service request message; and an individualization service server configured to recommend individualization services corresponding to the user profile and provide the recommended individualization services to the individualization service client, at the time of receiving the individualization service request services.

2. The individualization service providing system based on a user of claim 1, wherein the individualization service server again receives individualization services selected by a user among the individualization services provided to the individualization service client from the individualization service client to update the individualization services recommended corresponding to the user profile.

3. An individualization service client based on a user, comprising:
an individual information collection unit configured to collect user's individual information;
an individual information storage unit configured to store the collected individual information;
an anonymization processing unit configured to anonymize the individual information according a privacy policy;
a profile generation unit configured to generate a user profile for an individualization service request based on the anonymized individual information;
an individualization service processing unit configured to receive and execute individualization services transmitted from a server on a communication unit according to the individualization service request; and
a communication unit configured to transmit the individualization service request to the server on the communication network and receive the individualization services from the server.

4. The individualization service client based on a user of claim 3, wherein the individualization service processing unit feedback-transmits information regarding individualization services selected by a user among the individualization services received from the server to the server.

5. The individualization service client based on a user of claim 3, wherein the individualization service processing unit allows a client to use, as a feedback, information regarding the individualization services selected by a user among the individualization services received from the server and uses context information of a service to update an individual information storage unit.

6. The individualization service client based on a user of claim 3, wherein the anonymization processing unit determines a profile item through a profile item control and an item range control at the time of the anonymization of the individual information and determines a data range of the profile item.

7. The individualization service client based on a user of claim 3, further comprising a privacy policy storage unit configured to store the privacy policy for anonymizing the individual information.

8. An individualization service server based on a user, comprising:
a communication unit configured to receive an individualization service request through a communication network and transmit recommended individualization services according to the individualization service request;
an individualization service storage unit configured to store information regarding individualization services corresponding to a user profile;
an individualization service recommendation unit configured to analyze user profile information received along with the individualization service request at the time of receiving the individualization service request to recommend individualization services corresponding to the user profile; and
a feedback processing unit configured to receive user selection information regarding the individualization services to extract the user profile included in the selection information and store the extracted user profile in the individualization service storage unit.

9. The individualization service server based on a user of claim 8, wherein the individualization service storage unit stores the user profile information selecting the individualization services provided from the feedback processing unit and then, searches common data from the user profile information and adds the searched data to context information.

10. A method of providing individualization services based on a user, comprising:
collecting, by an individualization service client, user's individualization information;
generating a user profile by anonymizing the individual information according to a privacy policy transmitting the user profile to an individualization service server on a communication network, along with an individualization service request message;
recommending individualization services corresponding to the user profile;
providing the recommended individualization services to the individualization service client;
receiving individualization services corresponding to the user profile from the individualization service server; and
executing the received individualization services.

11. The method of claim 10, further comprising:
after the executing of the individualization services, using, by a client, selection information regarding individualization services executed by the user as a feedback and using context information of a service to update an individualization information storage unit.

12. The method of claim 10, further comprising:
after the providing of the recommended individualization services to the individualization service client, feedback-receiving user selection information regarding the recommended individualization services from the individualization client; and
extracting a user profile included in the selection information to update individual services.

13. The method of claim 10, wherein the user profile information is individual information that is anonymized individual information.
